(19) United States
(12) Patent Application Publication
(10) Pub. No.: US 2002/0043140 A1
(43) Pub. Date: Apr. 18, 2002

(54) Shadow line saw

(76) Inventor: Wally Rhua JR., Smithfield (AU)

Correspondence Address: Stetina Brunda Garred & Brucker- Lowell Anderson, Suite 250, 75 Enterprise, Aliso Viejo, CA, 92656, US

(21) Appl. No.: 09/898,504

(22) Filed: Jul. 3, 2001

(30) Foreign Application Priority Data
Jul. 4, 2000 (AU) PQ8552

(51) Int. Cl. B26D 1/00; B23D 49/00

(52) U.S. Cl. 83/13; 30/371; 83/835; 30/294; 30/314

(57) ABSTRACT

A shadow line saw for cutting building lining having a substantially planar blade support member with a guide surface and a grasping means support surface. An elongate blade is supported by the blade support member. The blade has a working edge with a plurality of saw teeth mounted therealong. A grasping handle extends from the grasping means support surface and is configured to permit an operator of the saw to exert a force on said blade parallel to the guide surface.

The present invention relates to a shadow line saw and, more particularly, to a shadow line saw and corresponding method for the selective and controlled cutting of building lining board such as plaster board and the like, thereby to form a shadow line therein.

### BACKGROUND

It is known in the art of ceiling paneling to leave a gap or an indent between the ceiling edge and the adjacent wall. Typically the gap is the order of 10 mm wide. The effect of the gap when lit by typical room lighting is to create a shadow effect around the perimeter of the ceiling, often called a “shadow line”.

It is important that the gap is formed accurately and predictably otherwise the desired architectural effect can be lost.

It is an object of at least preferred embodiments of the present invention to provide a device and a method by which an accurate and predictable gap may be formed.

### BRIEF DESCRIPTION OF INVENTION

Accordingly, in one broad form of the invention there is provided a shadow line saw for cutting building lining comprising:

(a) a substantially planar blade support member having a guide surface and a grasping means support surface;

(b) an elongate blade supported by said blade support member; said blade having a working edge with a plurality of saw teeth mounted there along;

(c) grasping means or grasping handle extending from said grasping means support surface adapted to permit an operator of said saw to exert a force on said blade parallel to said guide surface; said saw operable to cut a shadow line in said building lining.

Preferably said building lining comprises plasterboard.

Preferably said blade is supported between the plane of said first guide surface and the plane of said second grasping means support surface.

Preferably said blade is secured within a slot running the length of an edge of said saw; said slot extending a predetermined depth into said blade support member; said edge defined between said guide surface and said grasping means support surface.

Preferably said elongate blade is a non-rotating blade.

Preferably said elongate blade is aligned substantially parallel to said guide surface.

Preferably said saw incorporates fastening means for connection of said elongate blade in fixed, non-rotating relationship to said blade support member.

Preferably said fastening means does not extend through a plane of said guide surface.

Preferably said predetermined depth is less than 20 mm.

In a further broad form of the invention there is provided a method of forming a shadow line in building lining comprising applying the guide surface of the saw of claim 1 to a wall; sliding said saw over said wall whilst also urging said working edge of said blade into said building lining; thereby to cut from said lining a portion of said lining of width T; said width T defined by the distance between said blade and said guide surface.

Preferably T is in the range 5 to 20 mm.

More preferably T is in the range 5 to 15 mm.

Yet more preferably T is in the range 5 to 10 mm.

### BRIEF DESCRIPTION OF DRAWINGS

One embodiment of the present invention will now be described with reference to the accompanying drawings wherein:

FIG. 1 illustrates a ceiling incorporating a shadow line structure;

FIG. 2 is a perspective view of a shadow line saw according to a first embodiment of the present invention; and showing an instance of its usage;

FIG. 3 is a side view and an edge view of the shadow line saw of FIG. 2.

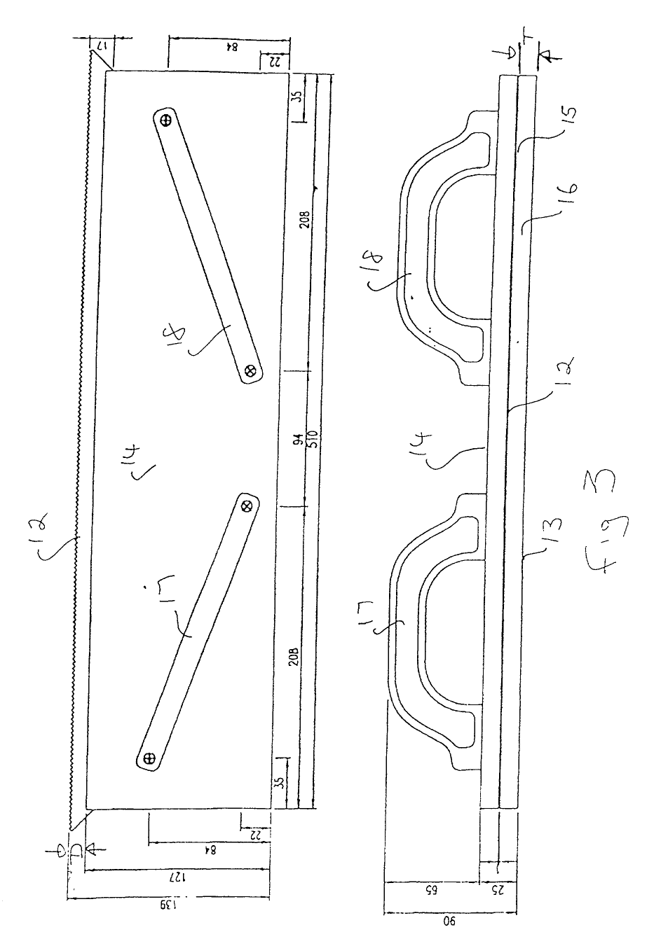

### DETAILED DESCRIPTION OF PREFERRED EMBODIMENT

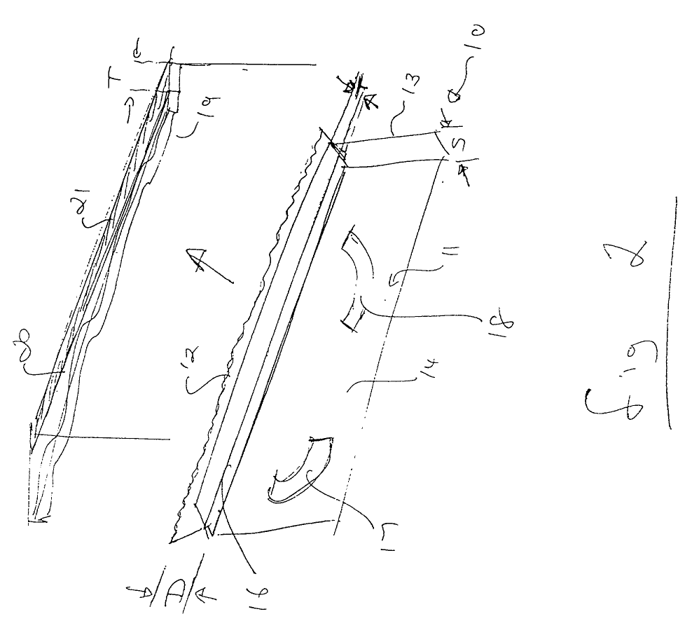

With reference to FIG. 2, initially, there is illustrated a shadow line saw 10 having a substantially planar blade support member 11 which supports saw blade 12.

In this embodiment the saw blade 12 is supported between the plane of a first guide surface 13 and the plane of a second grasping means support surface 14, also referred to herein as a grasping support surface 14.

More particularly, in this embodiment, the first guide surface 13 is mounted in opposed, planar relationship to second grasping means support surface 14 spaced a distance S from each other as illustrated in FIG. 2.

In this particular instance dimension S is approximately 25 mm. In preferred forms S lies in the range 20 to 50 mm.

In this instance blade 12 is secured within slot 15 running the length of edge 16 defined between first guide surface 13 and second grasping means support surface 14.

More particularly the slot 15 extends only a predetermined distance into blade support member 11, and in a preferred form, no more than 20 mm thereinto.

In this instance blade 12 extends a height D beyond edge 16. In addition blade 12 is displaced a distance T from first guide surface 13 along the full extent of edge 16.

In this instance distance T is approximately 10 mm. Generally the dimension T is selected so as to produce the desired gap to form the shadow line in the building lining and may typically lie in the range 5 to 20 mm and, more preferably, in the range 5 to 15 mm.

In this instance blade 12 is elongate and is maintained in a fixed relationship with respect to blade support member 11. More particularly, in this instance, blade 12 is a non-rotating blade and relies for its cutting action on relative movement of the blade with respect to building lining imparted solely by relative movement of the blade support member 11 with respect to the lining.

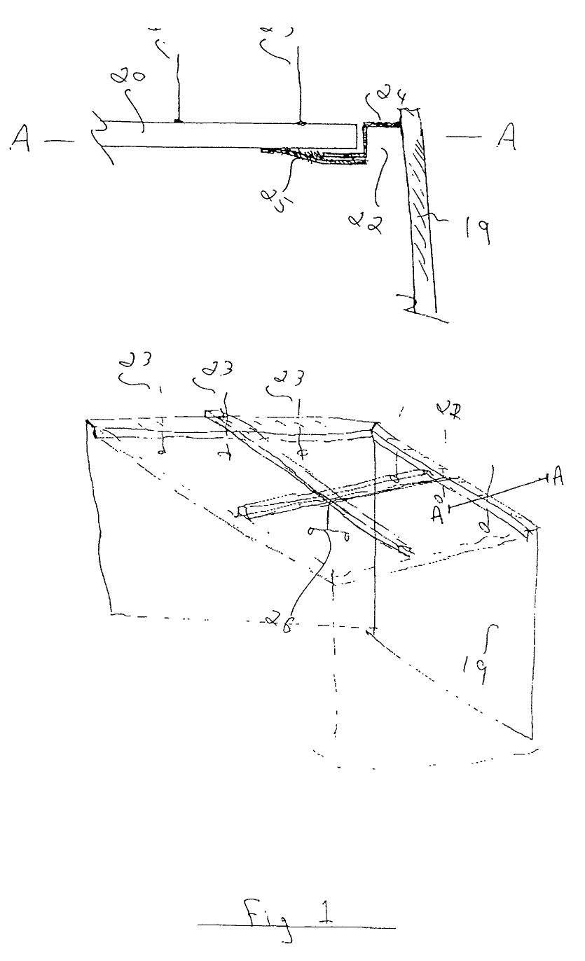

In use, with reference to FIGS. 1 and 2 a user of saw 10 grasps first handle 17 with one hand and second handle 18 by his or her other hand. The handles 17, 18 are anchored into second grasping means support surface 14 in such a way as to allow the user to place first guide surface 13 against wall 19 and slide the saw 10 backwards and forwards over the wall surface 19 whilst also urging blade 12 against ceiling lining 20 so as to cut entirely through edge portion 21 resulting in edge portion 21 being severed entirely from ceiling lining 20 thereby defining and leaving an edge portion gap 22 as best seen in FIG. 1.

The bulk of ceiling lining 20 remains suspended by suspension means 23.

The edge portion gap 22 is finished by the insertion of bracket 24 (commercially available as a “P50 bracket”) and finished against the underside of ceiling lining 20 by means of plaster 25 and smoothing as necessary ready for painting.

The end result is a well finished gap of width T and depth of approximately D extending around the periphery of ceiling lining 20 where it abuts wall 19.

Particularly when central room lighting such as light 26 is illuminated a clearly defined shadow line effect is observed around the edges of the ceiling lining 20.

It will be observed that where fastening means other than the slot 15 previously described are utilized for mechanical support of blade 12 with respect to blade support member 11 it is important that in no instance does the fastening means extend from blade 12 beyond dimension T so as to intersect the plane of first guide surface 13 as otherwise the fastening means would gouge the wall or like surface against which the first guide surface 13 is placed and moves during use of the saw 10.

The above describes only one embodiment of the present invention and modifications, obvious to those skilled in the art, can be made thereto without departing from the scope and spirit of the present invention.

1. A shadow line saw for cutting building lining comprising:
(a) a substantially planar blade support member having a guide surface and a grasping support surface;
(b) an elongate blade supported by said blade support member, said blade having a working edge with a plurality of saw teeth mounted therealong;
(c) a grasping handle extending from said grasping support surface adapted to permit an operator of said saw to exert a force on said blade parallel to said guide surface, said saw operable to cut a shadow line in said building lining.

2. The saw of claim 1 wherein said building lining comprises plasterboard.

3. The saw of claim 1 wherein said blade is supported between the plane of said first guide surface and the plane of said second grasping support surface.

4. The saw of claim 1 wherein said blade is secured within a slot running the length of an edge of said saw; said slot extending a predetermined depth into said blade support member; said edge defined between said guide surface and said grasping support surface.

5. The saw of claim 1 wherein said elongate blade is a non-rotating blade.

6. The saw of claim 1 wherein said elongate blade is aligned substantially parallel to said guide surface.

7. The saw of claim 1 incorporating fastening means for connection of said elongate blade in fixed, non-rotating relationship to said blade support member.

8. The saw of claim 7 wherein said fastening means does not extend through a plane of said guide surface.

9. The saw of claim 4 wherein said predetermined depth is less than 20 mm.

10. A method of forming a shadow line in building lining comprising applying the guide surface of the saw of claim 1 to a wall;
sliding said saw over said wall whilst also urging said working edge of said blade into said building lining; thereby to cut from said lining a portion of said lining of width T, said width T defined by the distance between said blade and said guide surface.

11. The method of claim 10 wherein T is in the range 5 to 20 mm.

12. The method of claim 10 wherein T is in the range 5 to 15 mm.

13. The method of claim 10 wherein T is in the range 5 to 10 mm.

14. The saw of claim 1 wherein said elongate blade is fixed to said blade support member.

15. The saw of claim 1 wherein said elongate blade is fixed to said blade support member and perpendicular thereto.

16. A shadow line saw for cutting building lining in a ceiling adjacent a wall perpendicular to the ceiling, comprising:
a substantially planar blade support having one edge forming a guide surface to engage the wall, and having a support surface;
an elongate blade supported by the blade support at an angle thereto, the blade having a working edge with a plurality of saw teeth mounted on the working edge;
a handle connected to and extending from the support surface at an angle to the support surface, the handle being configured to permit an operator of the saw to hold the handle and manipulate the saw to exert a force on the blade to cut a shadow line in the lining during use of the saw.

17. The shadow line saw of claim 16 wherein the angle is 90 degrees and the guide surface is perpendicular to the wall during use and the working edge is perpendicular to the lining during use.
